(19) United States
(12) Patent Application Publication
(10) Pub. No.: US 2010/0134983 A1
(43) Pub. Date: Jun. 3, 2010

(54) ELECTRIC MEMORY MODULE WITH COOLING BODIES

(76) Inventor: Karsten Rechenberg, Dormitz (DE)

Correspondence Address: HARNESS, DICKEY & PIERCE, P.L.C., P.O.BOX 8910, RESTON, VA, 20195, US

(21) Appl. No.: 12/452,288

(22) PCT Filed: Jun. 24, 2008
(86) PCT No.: PCT/EP2008/058017

§ 371 Date: Dec. 23, 2009

(30) Foreign Application Priority Data
Jun. 28, 2007 (DE) 10 2007 029 851.1

(51) Int. Cl. H01G 2/08

(52) U.S. Cl. 361/715

(57) ABSTRACT

An electric memory module is disclosed with at least two capacitors that are interconnected by an electrically conductive connection device. The memory module includes an electric insulation which electrically insulates the memory module, and the memory module includes a cooling body. According to at least one embodiment of the invention, the cooling body forms the connecting device and the electric insulation is applied to the outside of the cooling body.

### PRIORITY STATEMENT

This application is the national phase under 35 U.S.C. §371 of PCT International Application No. PCT/EP2008/058017 which has an International filing date of Jun. 24, 2008, which designates the United States of America, and which claims priority on German patent application number DE 10 2007 029 851.1 filed Jun. 28, 2007, the entire contents of each of which are hereby incorporated herein by reference.

### FIELD

At least one embodiment of the invention generally relates to an electric memory or storage module.

### BACKGROUND

A storage module is known from the French laid-open specification FR 2 863 400. The storage module has capacitors which are electrically connected to one another by way of heat sinks. Externally, the storage module is insulated by an insulating cover and an insulating base plate, in order to allow fitting to a rail vehicle.

US patent specification U.S. Pat. No. 5,214,564 discloses another storage module having capacitors and heat sinks; this storage module is intended to be mounted on a printed circuit board. An insulating intermediate board is inserted between the heat sinks and the capacitors, for electrical insulation of the heat sinks.

Furthermore, German laid-open specification DE 1 464 556 discloses a storage module with water cooling.

The life of capacitors, in particular of double-layer capacitors, is limited substantially by the thermal load to which the capacitors are subject during their operation.

### SUMMARY

At least one embodiment of the invention specifies a storage module which, by virtue of its design, can have a particularly long life.

At least one embodiment of the invention accordingly provides for an electrically insulating layer to be applied externally to the heat sinks, which electrically insulates the storage module on the outside.

One major advantage of the storage module according to at least one embodiment of the invention is that it allows very good heat dissipation, as a result of which the life of the storage module is very long, in comparison with already known storage modules. The electrical connection device or the electrical connection devices, which provides or provide the electrical connection for the capacitors, has or have a dual function according to at least one embodiment of the invention, specifically an electrical function and a thermal function. The connection devices are therefore used on the one hand for electrical connection of the capacitors, thus providing the electrical behavior desired from the storage module, that is to say for example with regard to the storage capacity and/or the output voltage; at the same time, the connection devices are also used as heat sinks and cool the capacitors, thus making it possible to ensure a relatively low operating temperature.

The position of the electrical insulation provided according to at least one embodiment of the invention also plays a major role: specifically, the invention provides that the electrical insulation on the electrical storage module be applied externally to the heat sinks, as a result of which the electrical insulation cannot form a thermal resistance between the heat sink and the capacitors. Overall, the storage module according to the invention therefore differs considerably from already known storage modules, in which the electrical insulation is arranged between the capacitors and the heat sinks or between the connection devices and the heat sinks, thus making it harder for heat to be dissipated from the capacitors to the heat sinks.

In at least one embodiment, the storage module ensures very effective heat dissipation by way of the combination according to at least one embodiment the invention of the arrangement of the electrical insulation externally on the heat sinks with the dual use of the connection devices, specifically on the one hand as heat sinks and on the other hand as a connection element.

By way of example, the electrical insulation may comprise an inorganic layer, for example composed of an oxide (for example aluminum oxide), or an organic layer, for example a lacquer or the like.

The intermediate spaces between the heat sinks are preferably also filled at least in places with electrical insulating material, in order to prevent possible short circuits.

The electrical insulating material in the intermediate spaces between the capacitors may, for example, be formed by a layer of the same material as that which is also applied externally as electrical insulation to the heat sinks. In this refinement, the electrical insulation is therefore used for external insulation of the storage module and at the same time also for insulation of the heat sinks and of the connection devices from one another.

### BRIEF DESCRIPTION OF THE DRAWINGS

The invention will be explained in more detail in the following text with reference to one example embodiment; in this case, by way of example, in the figures:

FIG. 1 shows a storage module which is not claimed, for a general explanation of the background to the invention, in which heat sinks and conductive connection devices are isolated from one another by electrical insulation, and

FIG. 2 shows one example embodiment of a storage module according to the invention.

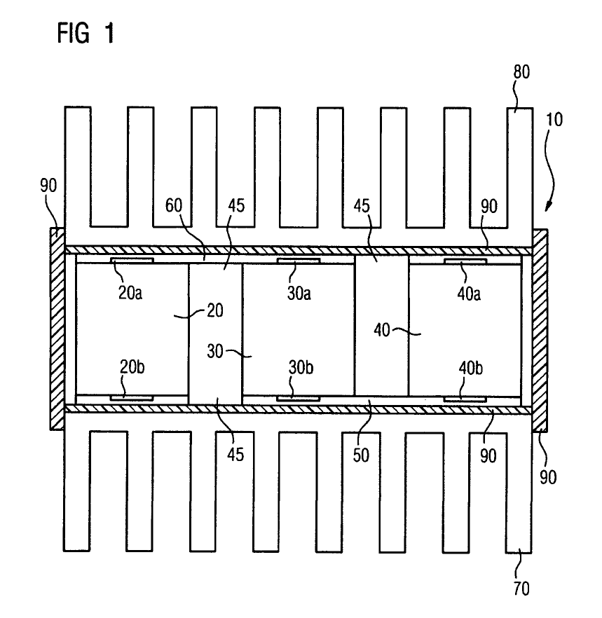

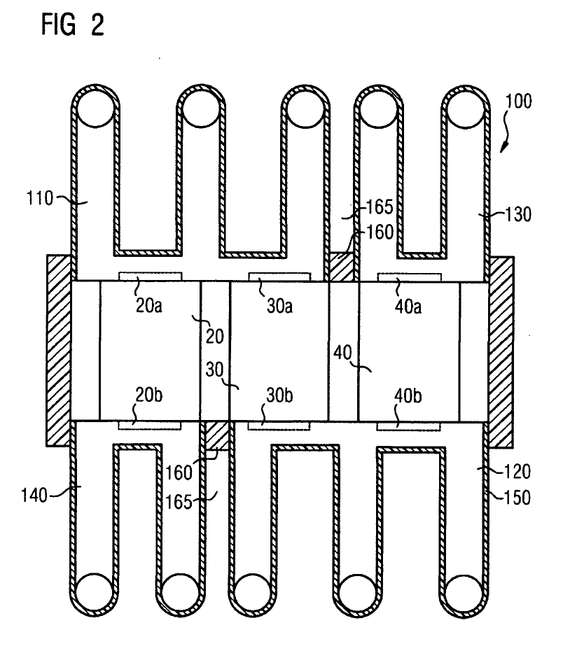

For the sake of clarity, the same reference symbols are used for identical or comparable components in FIGS. 1 and 2.

### DETAILED DESCRIPTION OF THE EXAMPLE EMBODIMENTS

FIG. 1 shows an electrical storage module which is annotated with the reference symbol 10. As can be seen, the storage module 10 has three capacitors 20, 30 and 40 which, for example, may be formed by double-layer capacitors and are isolated from one another by insulation material, for example, also air, 45. Each capacitor 20, 30 and 40 in each case has two connections, which are annotated with the reference symbols 20a, 30a, 40a and 20b, 30b, and 40b in FIG. 1.

By way of example, the three capacitors are electrically connected in series; two electrically conductive connection devices 50 and 60 are used for this purpose. The electrical connection device 50 connects the connections 30b and 40b of the two capacitors 30 and 40. The connection device 60 connects the connections 20a and 30a of the two capacitors 20 and 30, thus resulting in the three capacitors being connected in series.

Furthermore, the storage module 10 shown in FIG. 1 has two heat sinks, specifically a heat sink 70 and a heat sink 80. The two heat sinks 70 and 80 are isolated from the capacitors by electrical insulation 90 which sheaths the capacitors, and are therefore isolated from the electrically conductive connection devices 50 and 60.

During operation of the storage module 10, efficient heat dissipation from the capacitors 20, 30 and 40 to the heat sinks 70 and 80 is impeded by the electrical insulation 90, specifically because this creates an additional thermal resistance between the heat sinks and the capacitors. As a result of this additional thermal resistance, the temperature of the capacitors increases during operation, and reduces their life overall.

FIG. 2 shows one example embodiment of an electrical storage module according to the invention. This storage module is annotated with the reference symbol 100.

As can be seen in FIG. 2, the connections 20a and 30a of the two capacitors 20 and 30 are connected by means of an electrically conductive connection device 110, which at the same time also forms a heat sink.

The two connections 30b and 40b of the two capacitors 30 and 40 are also connected by a connection device, which has a dual function and is also used as a heat sink at the same time. This connection device or this heat sink is annotated with the reference symbol 120 in FIG. 2.

Furthermore, the figure shows two further heat sinks 130 and 140, which are connected to the connections 20b and 40a of the capacitors 20 and 40.

Since the heat sinks 110, 120, 130 and 140 are electrically directly connected to connections of the capacitors 20, 30 and 40, electrical insulation 150, which is applied externally to the heat sinks, is used for their external insulation. The electrical insulation 150 therefore forms the external layer of the storage module 100.

By way of example, the electrical insulation 150 may be formed by an inorganic or an organic layer (for example composed of oxide material such as aluminum oxide or from lacquer, etc.), which is applied to the heat sinks.

In order to electrically isolate the heat sinks from one another, electrical insulating material 160 is furthermore provided, which is arranged in intermediate spaces 165 between the heat sinks 110 and 130, as well as between the two heat sinks 120 and 140. The electrical insulating material 160 may be composed of the same material as the electrical insulation 150 on the heat sinks 110 to 140.

During operation of the electrical storage module 100, efficient heat dissipation from the area of the capacitors 20, and 40 is ensured because the capacitors are directly connected to the heat sinks 110, 120, 130 and 140, specifically both electrically and thermally; this is because there is no additional thermal resistance between the heat sinks and the capacitors.

Although the storage module 100 shown in FIG. 2 also has electrical insulation which provides external electrical insulation for the capacitors, in contrast to the storage module 10 as shown in FIG. 1, this insulation is, however, not fitted between the heat sinks and the capacitors, but externally to the heat sinks, thus achieving better heat dissipation overall.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An electrical storage module comprising:
at least two capacitors, electrically connected to one another by way of heat sinks;
and
an electrically insulating layer, applied externally to the heat sinks and electrically insulating the storage module on an outside of the storage module.

2. The storage module as claimed in claim 1, wherein the heat sinks include cooling ribs, and wherein the electrically insulating layer is applied externally to the cooling ribs.

3. The storage module as claimed in claim 1, wherein intermediate spaces between the heat sinks are filled, at least in a portion thereof, with electrical insulating material, and wherein the electrical insulating material in the intermediate spaces is composed of the same material as that which is applied externally as an electrically insulating layer to the heat sinks.

4. The storage module as claimed in claim 1, wherein the electrical insulation has an inorganic layer.

5. The storage module as claimed in claim 1, wherein the electrical insulation has an organic layer.

6.-8. (canceled)

9. The storage module as claimed in claim 2, wherein intermediate spaces between the heat sinks are filled, at least in a portion thereof, with electrical insulating material, and wherein the electrical insulating material in the intermediate spaces is composed of the same material as that which is applied externally as an electrically insulating layer to the heat sinks.

10. The storage module as claimed in claim 2, wherein the electrical insulation has an inorganic layer.

11. The storage module as claimed in claim 2, wherein the electrical insulation has an organic layer.

12. The storage module as claimed in claim 3, wherein the electrical insulation has an inorganic layer.

13. The storage module as claimed in claim 3, wherein the electrical insulation has an organic layer.

14. The storage module as claimed in claim 9, wherein the electrical insulation has an inorganic layer.

15. The storage module as claimed in claim 9, wherein the electrical insulation has an organic layer.
